(19) United States
(12) Patent Application Publication
(10) Pub. No.: US 2023/0037780 A1
(43) Pub. Date: Feb. 9, 2023

(54) COMPUTING DEVICE WITH ONE OR MORE HARDWARE ACCELERATORS DIRECTLY COUPLED WITH CLUSTER OF PROCESSORS

(71) Applicant: AZIMUTH TECHNOLOGY, LLC, Austin, TX (US)

(72) Inventor: Kelvin Goveas, Austin, TX (US)

(21) Appl. No.: 17/870,572

(22) Filed: Jul. 21, 2022

Related U.S. Application Data
(60) Provisional application No. 63/224,352, filed on Jul. 21, 2021.

(51) Int. Cl. G06F 9/38; G06F 9/30; G06F 17/16; H04L 9/06

(52) U.S. Cl. CPC G06F 9/3891; G06F 9/30101; G06F 17/16; H04L 9/0631

(57) ABSTRACT

A computing device having a tightly attached or closely attached hardware accelerator directly coupled with one or more processors for efficient uses of the hardware accelerator for executing specific functions are described. According to an embodiment, the hardware accelerator is instantiated inside the main processor unit and interfaces to a load-store unit (LS) using virtual addresses. The hardware accelerator instantiated inside the main processing unit (e.g., core) is referred to as a tightly attached hardware accelerator. In an alternative embodiment, the hardware accelerator is instantiated inside a cluster of processor cores. The hardware accelerator that is instantiated inside the cluster of processor cores but not inside a specific processor core is referred to as a closely attached hardware accelerator.

### CROSS-REFERENCE TO RELATED APPLICATIONS

This application claims priority to U.S. Provisional Patent Application No. 63/224,352, Attorney Docket No. KGOV001USP and title “SYSTEM WITH TIGHTLY ATTACHED OR CLOSELY ATTACHED HARDWARE ACCELERATOR” filed on Jul. 21, 2021; all of which are hereby incorporated by reference in their entirety.

### FIELD OF THE DISCLOSURE

Embodiments of the present invention generally relate to a computer system architecture. In particular, embodiments of the present invention relate to a computing device having a hardware accelerator directly coupled with one or more processors of the computing device.

### BACKGROUND OF THE DISCLOSURE

Hardware accelerators have long been used for the faster processing of data. Hardware accelerators are designed to perform some functions more efficiently than are possible in software running on a general-purpose Central Processing Unit (CPU) or a system of Chip (SoC). Hardware Accelerators (HWA) allow computing systems to accelerate the performance of a particular class of applications by providing hardware support at the algorithmic level. They have been employed in the past in x86 (Intel/AMD) system-on-chip (SOC), as well as ARM SOCs, to accelerate applications such as cryptography, which provide data privacy as well as authentication. For accelerating graphics-related applications, a graphics accelerator is used, where graphics-related processing is migrated from a processor to a dedicated hardware accelerator. Compared with the processor, the dedicated hardware accelerator can execute these graphics functions within a shorter time. In addition, there are other types of hardware accelerators, such as an accelerator for processing an Extensible Markup Language, an accelerator for executing compression and decompression, a floating-point processor for executing a floating-point operation, and an accelerator for executing encryption and decryption. In general, any hardware that can execute a function allocated by a processor can be considered a hardware accelerator.

An example of an application-specific hardware accelerator is disclosed in the United States granted Patent No. 9,153,230 titled “Mobile speech recognition hardware accelerator” (the '230 patent). The '230 patent discloses a method for executing a mobile speech recognition software application based on a multi-layer neural network model provides a hardware accelerator in the mobile device to classify one or more frames of an audio signal. The hardware accelerator includes a multiplier-accumulator (MAC) unit to perform matrix multiplication operations involved in computing the neural network output.

Another application-specific hardware accelerator is disclosure in the United States granted Patent No. 10,831,713 titled “Hardware acceleration for compressed computation database” (the '713 patent). The '713 patent discloses a machine, systems, methods, and computer program products for hardware acceleration. The data processing system of the '713 patent includes a plurality of computational nodes, each performing a corresponding operation for data received at that node, and a metric module to determine a compression benefit metric pertaining to the performance of the corresponding operations of one or more computational nodes with recompressed data, and an accelerator module to decompress the data for processing by the one or more computational nodes based on the compression benefit metric indicating a benefit gained by using the recompressed data. A computational node may perform operations including arithmetic or database operations, e.g., aggregation or joins on input data from a source such as a storage device or a cache, to produce output data. A computational node also may export data to a database client or may act as a pure source or pure sink, synthesizing or consuming data.

The United States granted Patent No. 10,761,877 titled “Apparatuses, methods, and systems for blockchain transaction acceleration” (the '877 patent) describes methods and apparatuses relating to accelerating blockchain transactions. In one embodiment, a processor includes a hardware accelerator to execute an operation of a blockchain transaction, and the hardware accelerator includes a dispatcher circuit to route the operation to a transaction processing circuit when the operation is a transaction operation and route the operation to a block processing circuit when the operation is a block operation. In another embodiment, a processor includes a hardware accelerator to execute an operation of a blockchain transaction; and a network interface controller including a dispatcher circuit to route the operation to a transaction processing circuit of the hardware accelerator when the operation is a transaction operation and route the operation to a block processing circuit of the hardware accelerator when the operation is a block operation.

In most existing computer systems, a hardware accelerator is attached to the CPU (also referred to as the main processing core) through a peripheral bus. In existing computer systems, the hardware accelerator is relatively far away from the main processor core on which software is run, and hence there is a latency when the processes need to be transferred from the main processing core to the hardware accelerator and vice-versa. This type of attachment is referred to as loosely attached and is shown in FIG. 1. As shown in FIG. 1, a system 100 includes a hardware accelerator (HWA) 102 attached to a peripheral bus at the SOC level to facilitate the acceleration of firmware, kernel, and application software. The hardware accelerator 102 interconnects with central processing units (CPUs)104a-n through a system bridge 106. The system 100 includes an I/O 110 to receive instructions and data from external interfaces. Instructions, data, and process states are saved in a memory unit 108. Instructions and data shared through system bridge 106 are stored in memory 108 when a process is transferred from any CPUs 104a-n to the hardware acceleration 102. Alternatively, the instructions to configure and specify the parameters of a new task can be written directly to the HWA 102 using memory-mapped registers via loads using software running on one or the CPUs. In this arrangement, the HWA 102 only needs to access data from the main memory and not the instructions. The loosely attached hardware accelerator 102 has several issues, such as communication latency, inefficient exception reporting, delayed interrupt reporting, and inefficiency in pausing and resuming certain tasks. Therefore, there is a need for an alternate system design that overcomes some of the above-lighted issues.

The present disclosure makes possible a number of the needed solutions and makes a material and substantial improvement to the current state of the art for proving a system that better integrates a hardware accelerator with a main processing unit.

### BRIEF SUMMARY OF THE DISCLOSURE

A computing device and its system architectures are disclosed in the present disclosure. In an embodiment, the computing device includes a cluster of processors and one or more hardware accelerators directly coupled with the cluster of processors to facilitate the acceleration of at least one firmware, kernel, and application software associated with the computing device. Each processor from the cluster of processors is directly coupled with a dedicated hardware accelerator from one or more hardware accelerators by interfacing the dedicated hardware accelerator with one of the Load Store Unit (LS) and Level 2 cache of the corresponding processor from the cluster of processors using the virtual address of the corresponding processor.

In an embodiment, each of the one or more hardware accelerators comprises one or more first interfaces with the memory subsystem of the corresponding processor, wherein the one or more first interfaces comprise a special register interface, memory subsystem interface, and Completion/Interrupt/Exception interface with commit unit of the corresponding processor.

In an embodiment, one or more hardware accelerators along with the cluster of processors are configured to perform operations selected from crypto acceleration, transcendental floating-point functions, quad-precision floating-point, integer, and floating-point matrix multiply, and machine learning using neural networks for training.

The present disclosure further discloses a computing device comprising a cluster of processors and a hardware accelerator directly coupled with the cluster of processors to facilitate acceleration of at least one of firmware, kernel, and application software associated with the computing device. The hardware accelerator is directly coupled with the cluster of processors by interfacing the hardware accelerator with a standard interconnect associated with the cluster of processors using the physical addresses of the cluster of processors.

In an embodiment, the hardware accelerator comprises one or more second interfaces with the cluster of processors, wherein the one or more second interfaces comprise Memory Mapped Register (MMR) interface, coherent hub interface, a memory interface, an interrupt interface, and an exception interface.

In an embodiment, the hardware accelerator along with the cluster of processors are configured to perform operations selected from crypto acceleration, transcendental floating-point functions, quad-precision floating point, integer, and floating-point matrix multiply, and machine learning using neural networks for training.

The present disclosure further discloses a hardware accelerator for performing an operation of crypto acceleration. The hardware accelerator comprises first predefined number of crypto pipes, a common special register/MMR block with second predefined number of special register banks, and a shared carry less multiplier. The first predefined number and the second predefined number are selected based on the crypto processing bandwidth requirements of a computing device comprising the hardware accelerator. The hardware accelerator is directly coupled with a cluster of processors of the computing device, to perform the operation of the crypto acceleration.

In an embodiment, a crypto pipe from the first predefined number of crypto pipes comprises a pipelined functional unit configured to take two clock cycles to perform at least one of Advanced Encryption Standard (AES) key schedule, AES encode, and AES decode.

The Features and advantages of the subject matter hereof will become more apparent in light of the following detailed description of selected embodiments, as illustrated in the accompanying FIGUREs. As will be realized, the subject matter disclosed is capable of modifications in various respects, all without departing from the scope of the subject matter. Accordingly, the drawings and the description are to be regarded as illustrative in nature.

### BRIEF DESCRIPTION OF THE DRAWINGS

The present subject matter will now be described in detail with reference to the drawings, which are provided as illustrative examples of the subject matter to enable those skilled in the art to practice the subject matter. It will be noted that throughout the appended drawings, features are identified by like reference numerals. Notably, the FIGUREs and examples are not meant to limit the scope of the present subject matter to a single embodiment, but other embodiments are possible by way of interchange of some or all of the described or illustrated elements and, further, wherein:

FIG. 1 illustrates a conventional system architecture of a computing device;

FIG. 2A illustrates an embodiment of the system architecture of a computing device with a tightly attached hardware accelerator, in accordance with an embodiment of the present disclosure;

FIG. 2B illustrates an embodiment of system architecture of a computing device with a closely attached hardware accelerator, in accordance with an embodiment of the present disclosure;

FIG. 2C illustrates an embodiment of system architecture of a computing device with a closely attached “passive” hardware accelerator, in accordance with an embodiment of the present disclosure.

FIG. 3 illustrates an exemplary microarchitecture of a computing device with a hardware accelerator closely attached to a processor, in accordance with an embodiment of the present disclosure;

FIG. 4A illustrates an exemplary data path of a hardware accelerator designed to perform cryptography, in accordance with an embodiment of the present disclosure;

FIG. 4B shows memory interface of the hardware accelerator, in accordance with an embodiment of the present disclosure;

FIG. 5 illustrates detailed logic used inside one of crypto pipes of hardware accelerator, in accordance with an embodiment of the present disclosure;

FIG. 6A is a timing diagram illustrating how signal transitions on hardware interface of a hardware accelerator when accepting, processing, and completing a request, in accordance with an embodiment of the present disclosure;

FIG. 6B is a timing diagram illustrating how a stop request is processed by a hardware accelerator, in accordance with an embodiment of the present disclosure;

FIG. 7A illustrates an exemplary system having a hardware processor attached with a hardware accelerator, in accordance with an embodiment of the present disclosure;

FIG. 7B illustrates another exemplary system having a hardware processor attached to a hardware accelerator, in accordance with an embodiment of the present disclosure; and

FIG. 8 illustrates the component of an example computer system, in accordance with an embodiment of the present disclosure.

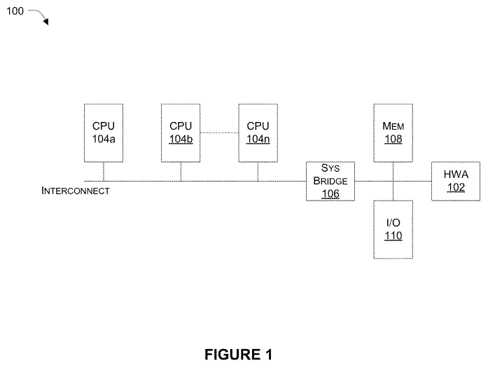

### DETAILED DESCRIPTION OF THE EMBODIMENTS

In the following description, for purposes of explanation, numerous specific details are set forth in order to provide a thorough understanding of the present disclosure. It will be apparent, however, to one skilled in the art that the present disclosure is not limited to these specific details.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments.

Further, the terms “a” and “an” herein do not denote a limitation of quantity but rather denote the presence of at least one of the referenced items. As used in the description herein and throughout the claims that follow, the meaning of “a,” “an,” and “the” includes plural reference unless the context dictates otherwise. Also, as used in the description herein, the meaning of “in” includes “in” and “on” unless the context dictates otherwise.

Moreover, various features are described, which may be exhibited by some embodiments and not by others. Similarly, various requirements are described, which may be requirements for some embodiments but not for other embodiments.

The terms “connected” or “coupled” and related terms are used in an operational sense and are not necessarily limited to a direct connection or coupling. Thus, for example, two devices may be coupled directly or via one or more intermediary media or devices. As another example, devices may be coupled in such a way that information can be passed therebetween, while not sharing any physical connection with one another. Based on the disclosure provided herein, one of ordinary skill in the art will appreciate a variety of ways in which connection or coupling exists in accordance with the aforementioned definition.

If the specification states a component or feature “may,” “can,” “could,” or “might” be included or have a characteristic, that particular component or feature is not required to be included or have the characteristic.

Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Embodiments described herein may be discussed in the general context of computer-executable instructions residing on some form of computer-readable storage media, such as program modules, executed by one or more computers or other devices. By way of example, and not limitation, computer-readable storage media may include non-transitory computer-readable storage media and communication media; non-transitory computer-readable media include all computer-readable media except for a transitory, propagating signal. Generally, program modules include routines, programs, objects, components, data structures, etc., that perform particular tasks or implement particular abstract data types. The functionality of the program modules may be combined or distributed as desired in various embodiments.

Some portions of the detailed description that follows are presented and discussed in terms of a process or method. Although steps and sequencing thereof are disclosed in figures herein describing the operations of this method, such steps and sequencing are exemplary. Embodiments are well suited to performing various other steps or variations of the steps recited in the flowchart of the figure herein and in a sequence other than that depicted and described herein. Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those utilizing physical manipulations of physical quantities. Usually, although not necessarily, these quantities take the form of electrical or magnetic signals capable of being stored, transferred, combined, compared, and otherwise manipulated in a computer system. It has proven convenient at times, principally for reasons of common usage, to refer to these signals as transactions, bits, values, elements, symbols, characters, samples, pixels, or the like.

In some implementations, any suitable computer-usable or computer-readable medium (or media) may be utilized. The computer-readable medium may be a computer-readable signal medium or a computer-readable storage medium. The computer-usable, or computer-readable, storage medium (including a storage device associated with a computing device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fibre, a portable compact disc read-only memory (CD-ROM), an optical storage device, a Digital Versatile Disk (DVD), a static random access memory (SRAM), a memory stick, a floppy disk, a mechanically encoded device such as punch-cards or raised structures in a groove having instructions recorded thereon, a media such as those supporting the Internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in computer memory. In the context of the present disclosure, a computer-usable or computer-readable, the storage medium may be any tangible medium that can contain or store a program for use by or in connection with the instruction execution system, apparatus, or device.

In some implementations, a computer-readable signal medium may include a propagated data signal with computer readable program code embodied therein, for example, in baseband or as part of a carrier wave. In some implementations, such a propagated signal may take any of a variety of forms, including, but not limited to, electromagnetic, optical, or any suitable combination thereof. In some implementations, the computer-readable program code may be transmitted using any appropriate medium, including but not limited to the Internet, wireline, optical fibre cable, RF, etc. In some implementations, a computer-readable signal medium may be any computer-readable medium that is not a computer-readable storage medium, and that can communicate, propagate, or transport a program for use by or in connection with an instruction execution system, apparatus, or device.

In some implementations, computer program code for carrying out operations of the present disclosure may be assembler instructions, instruction-set-architecture (ISA) instructions, machine instructions, machine-dependent instructions, microcode, firmware instructions, state-setting data, or either source code or object code written in any combination of one or more programming languages, including an object-oriented programming language such as Java®, Smalltalk, C++ or the like. Java and all Java-based trademarks and logos are trademarks or registered trademarks of Oracle and/or its affiliates. However, the computer program code for carrying out operations of the present disclosure may also be written in conventional procedural programming languages, such as the “C” programming language, PASCAL, or similar programming languages, as well as in scripting languages such as JavaScript, PERL, or Python. In present implementations, the used language for training may be one of Python, TensorFlow, Bazel, C, C++. Further, the decoder in the user device (as will be discussed) may use C, C++, or any processor-specific ISA. Furthermore, assembly code inside C/C++ may be utilized for the specific operation. Also, ASR (automatic speech recognition) and G2P decoder along with the entire user system can be run in embedded Linux (any distribution), Android, iOS, Windows, or the like, without any limitations. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider). In some implementations, electronic circuitry including, for example, programmable logic circuitry, field-programmable gate arrays (FPGAs) or other hardware accelerators, micro-controller units (MCUs), or programmable logic arrays (PLAs) may execute the computer-readable program instructions/code by utilizing state information of the computer-readable program instructions to personalize the electronic circuitry, in order to perform aspects of the present disclosure.

In some implementations, the flowchart and block diagrams in the Figures illustrate the architecture, functionality, and operation of possible implementations of apparatus (systems), methods, and computer program products according to various implementations of the present disclosure. Each block in the flowchart and/or block diagrams, and combinations of blocks in the flowchart and/or block diagrams, may represent a module, segment, or portion of code, which includes one or more executable computer program instructions for implementing the specified logical function(s)/act(s). These computer program instructions may be provided to a processor of a general-purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some implementations, the functions noted in the block(s) may occur out of order noted in the figures. For example, two blocks shown in succession may be executed substantially concurrently, or the blocks may sometimes be executed in the reverse order, depending upon the functionality involved.

In some implementations, these computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

In some implementations, the computer program instructions may also be loaded onto a computer or other programmable data processing apparatus to cause a series of operational steps to be performed (not necessarily in a particular order) on the computer or other programmable apparatus to produce a computer-implemented process such that the instructions which execute on the computer or other programmable apparatus provide steps for implementing the functions/acts (not necessarily in a particular order) specified in the flowchart and/or block diagram block or blocks or combinations thereof.

The present disclosure teaches a modified system architectures of a computing device where one or more hardware accelerators are directly coupled with a cluster of processors. The direct coupling of the hardware accelerator is achieved by coupling each of the one or more processors with a dedicated hardware accelerator or coupling a single hardware accelerator with the cluster of processors. Coupling each of one or more processors with the dedicated hardware accelerator may also be referred to as the hardware accelerator tightly attached to a corresponding processor. Coupling the single hardware accelerator with the cluster of processors may be referred to as the hardware accelerator closely attached to the cluster of processors.

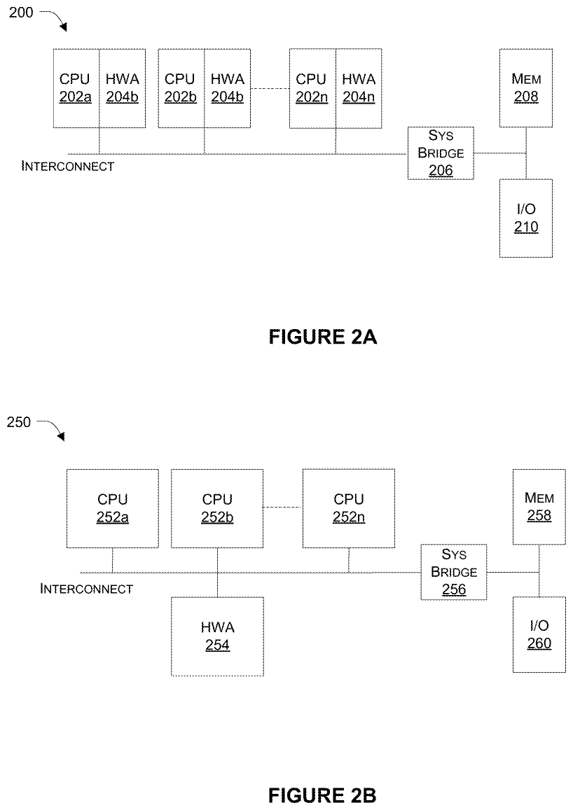

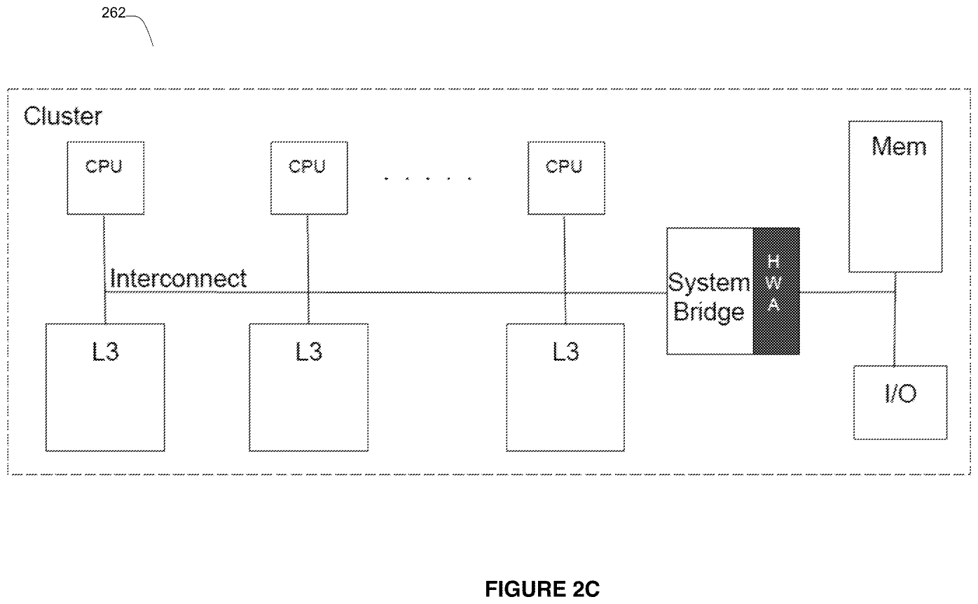

FIG. 2A illustrates system architecture of a computing device with tightly attached hardware accelerator, in accordance with an embodiment of the present disclosure. In an embodiment, a system 200 includes a cluster of processors 202a-n(e.g., processing units, processor cores, central processing units, etc.), each having a tightly attached hardware accelerator 204a-n. Each processor from the cluster of processors 202a-n includes a hardware accelerator. For example, processor 202a, processor 202b, and processor 202n respectively are coupled with a hardware accelerator 204a, hardware accelerator 204b, and hardware accelerator 204n tightly attached. System 200 couples the hardware accelerator 204a inside the processor 202a. The hardware accelerator 204a interfaces to the processor's load-store unit (LS) or Level 2 cache using virtual addresses. The hardware accelerator 204a in the proposed arrangement may be associated with a thread running on the processor 202a, as it can use the translation context of the thread. The system 200 may receive data, instructions, and commands through I/O interface 210 and write to memory 208. The hardware accelerator 204a-n is tightly attached to the memory subsystem inside the processor units 202a-n and has several interfaces, such as a special register (CSR) interface, memory subsystem interface, and completion/interrupt/Exception interface with commit unit (CT).

The special register (CSR) interface is used to read/write registers, such as HWA control and status (HwaCtl), an Initialization Vector (IV), Round key (RK), and a number of elements to process (NLEN), which live in the HWA. The CSR interface is used to read/write different 128-bit special registers via special software register read/write instructions (e.g., csrrs and csrrw instructions) in CPUs or cores. Two 64-bit accesses would be required in a 64-bit core, one to the low half and the other to the high half for each 128-bit register. The special registers are stored in the special register block. The starting VAs are incremented, and the number of remaining elements, HwaLen, is decremented as elements are processed using temporary registers. The values are written back into the special registers in HwaCsr when processing is stopped. The special registers include registers for Round Key (Lo/Hi), an initialization vector (Lo/Hi), starting VA of plain (cipher) text block to load from, starting VA of cipher (plain) text block to store to, and a number of elements that remains to be processed in HwaLen.

Using the CSR interface, a write to HwaCmd may be performed with Start=1 indicating a new request or resumption of a prior request to the HWA. The Start and Stop bits in HwaCmd are stateless bits that are write-only. The “Done” bit in HwaCtl is a state bit that indicates whether processing has been completed, either successfully or with an error. The next block to process can be determined from the HwaAddrin, HwaAddrOut, and HwaLen CSRs, which were updated on a Stop request, to support the restoration of a context that had been swapped out. The HwaMode[2:0] input from CT can indicate the privilege mode of the request. This is used later at completion of processing to set the corresponding “Irq” bit. HWA csrs must be restored after address and translation csrs, such as satp for the RISC-V architecture. HwaCtl must be the final HWA CSR to be restored. HwaCmd does not need to be saved or restored.

The memory subsystem interface is used with the LS in cores that have an L1 data cache (DL1) that is virtually addressed and physically tagged. With the memory subsystem interface, HWA issues read and write requests to one or more pipes in the load-store unit using the maximum supported size (e.g., 16-bytes) using aligned virtual addresses. Further, HWA can receive one load return bus per pipe together with exceptional status. Further, the memory subsystem interface is with the L2 in cores which have a DL1 that is virtually addressed and virtually tagged. The data TLB (DTLB) is part of the L2 pipeline and is looked up on a DL1 miss to convert virtual addresses into physical addresses. HWA issues read and write requests to the L2 using aligned virtual addresses (VA).

In an embodiment, the memory subsystem interface can be used to read requests, read data, write requests and write data. For example, the memory subsystem interface is used for 64-byte line read request and return data to read 4×16-byte plain (cipher) text per clock, 16-byte write request and data to store 1×16-byte cipher (plain) text per clock. This provides unaligned virtual addresses that are not supported and result in an unaligned load/store exception and when HWA receives 64-byte data together with exceptional status information from L2. The memory subsystem interface can be attached with an L2 cache in cores that have a DL1 that is virtually addressed and virtually tagged. The data TLB (DTLB) can be part of the L2 pipeline and is looked upon as a DL1 miss to convert virtual addresses into physical addresses. HWA issues read and write requests to the L2 using aligned virtual addresses (VA). A 64-byte line read request can be used to return 4×16-byte plain (cipher) text data elements per clock. A 16-byte write request can be used to store 1×16-byte cipher (plain) text per clock. As one will appreciate, unaligned virtual addresses are not supported and result in an unaligned load/store exception. HWA 204a-n can receive 64-byte data together with exceptional status information from L2. In another embodiment, an alignment shifter can be added inside HWA to align unaligned 64-byte lines into 128-bit elements, allowing support for unaligned accesses.

The system 200 can process the read request using the memory subsystem interface. Requests for a 64-byte aligned line fill using a VA can be injected into an HWA read request queue (HWRQ) inside the L2 hierarchy. A credit-based interface can be used to write and read the queue in order to avoid a combinational timing path from the HWA request to the HWA accept the signal, which could have a long route. The initial request is sent with an “unknown” memory type.

For reading data, 64-byte fill data may be returned. If a read request to a WB mem type hits in DL2, the 64-byte line is returned from the DL2. If a read request misses in DL2, the 64-byte line is fetched from the cluster as normal either from the UL3 or external memory. If an access fault, page fault, or data corruption is detected as part of the read access, an error status is returned which will cause HWA to stop processing and register an error status in HwaCtl as well as drive the HwaExcp outputs.

For writing request or data, request to store a 16-byte line is injected into a dedicated HWA write request queue (HWWQ). 16-bytes of write data are stored. A write combining buffer can be added to coalesce 16-byte writes into a 64-byte line to reduce DL2 write bandwidth from the HWA for WB and WC memory. It has been observed that the peak write bandwidth for an HWA with a 128-bit data path can be 1×16-byte write every 11 clocks which also implies 1×16-byte load every 13-clocks.

If the write request hits in DL2, the 16-byte line is written. If the write request misses in DL2, the 64-byte line is fetched from the cluster as normal, either from the UL3 or external memory. If an access fault, page fault, or data corruption is detected as part of the read access, an error status is returned, which will cause HWA to stop processing and register an error status in HwaCtl.

In an embodiment, the HWA 204a-n includes a completion /interrupt/exception interface with commit unit (CT) that sends a request to the HWA 204a-n to stop processing at the next available opportunity, when the core is waiting to process an interrupt. For instance, this could be due to the OS wanting to swap out the thread. In an embodiment, the completion/Interrupt /Exception interface can receive an Interrupt request from HWA and send it to CT, which indicates successful completion of processing in asynchronous mode. Similarly, the Exception interface receives an exception from the HWA->CT, which indicates an exception occurred during a read or write request to the memory subsystem. CT would vector to the appropriate exception software handler and, on a RISC-V core, update the “mcause” register, just as if the exception had occurred on a load or store op. The exception pc, mepc, in this case, would point to an unrelated instruction because the instructions to configure the HWA would have already been retired. An exception may occur due to one of the following
1) A page fault encountered in VA->PA translation,
2) An access fault encountered for a physical address,
3) Virtual address is unaligned, and Data corruption.

Interrupt indication from HWA to CT, HwaIrq[2:0], can indicate completion of processing in asynchronous mode. There are 3 bits in RV for M mode, HS mode, and U mode, respectively. In the U-mode, the Irq bit will not be asserted for parts that do not support the user-mode interrupt extension. When accompanied by HwaDone output indication, HwaIrq[2:0] indicates that processing has terminated. CT asserts HwaIrqAck when the interrupt is accepted, followed by HWA de-asserting HwaIrq. When HwaDone is not set, it indicates that processing was interrupted, and further work remains before HwaDone can be set.

Error indication from HWA to CT, HwaExcp[3:0], can indicate whether an access fault, page fault, unaligned fault, or data corruption occurred on a load or store. In the event of an exception, HwaMtval captures the virtual address of the faulting operation. HWA contains a shadow copy of the architectural mtval register and participates in its maintenance. CT uses HwaExcp to vector to an access fault, page fault, or unaligned exception, in the same manner in which this exception would have been taken if it had been reported by a load/store operation. The idle indication, HwaIdle, from HWA to CT indicates that HWA is processing a request. When HwaIdle is asserted, it indicates that HWA is idle, which could be due to the completion of the request or acknowledgment of an interrupt request.

FIG. 2B illustrates system architecture of a computing device with a closely attached hardware accelerator, in accordance with an embodiment of the present disclosure. In an embodiment, a system 250 includes a hardware accelerator 254 which can be attached inside a processor cluster 252a-n as opposed to a peripheral bus at the SOC level to facilitate the acceleration of firmware, kernel, or application software. The system 250 may receive data, instructions, and commands through I/O interface 260 and write to memory 258. A system bridge 256 connects the CPUs, hardware accelerator 254 with I/O interface 260, memory 208, and other components of the system 254. In an embodiment, the hardware accelerator 254 that is coupled inside the cluster of processor 252a-n but not inside a specific processor core is referred to as a closely attached hardware accelerator. The closely attached hardware accelerator interfaces to a standard industry interconnect, such as ARM CHI, with physical addresses. As one will appreciate, a closely attached hardware accelerator is shared across multiple processor cores. The HWA 254 may be coupled inside one or more L3 slices in the cluster clock domain. The HWA 254 may behave as another core from the view of the interconnect, with a unique target ID, issuing its read and write requests, using aligned physical addresses.

The system 250 with a closely attached hardware accelerator includes one or more of a Memory Mapped Register (MMR) interface, a memory interface (e.g., CHI or AXI), an interrupt interface, and an exception interface. As one will appreciate, the special register (CSR) interface of the system 200 is replaced with a Memory-Mapped Register (MMR) interface, but the list of special registers may remain the same. Firmware or software running on any processor unit or core of the cluster of processor units can issue a request to the hardware accelerator 254 using its HwaCmd, HwaCfg, and HwaCtl MMR address. The MMR interface provides functionality for reading and writing special registers similar to that of the special register interface of system 200 with a tightly attached hardware accelerator. The Vector bit in HwaCtl supports Linux scatter-gather lists via the ready( )and writev( )commands which repurpose MMRs, such as HwaAddrin(Out)List (a pointer to input array), HwaOutList (pointer to output array), and HwaLen (number of elements in an array. Each element of the array contains 16-byte data in memory used for Addr (8-bytes address to start of the region) and Len (8-bytes, a number of dwords in region). On a HwaStop request, the fields of the current element in the array will be updated with the address of the next dword to process and the length, with the remaining number of dwords to process.

The system 250 includes the memory interface that allows the hardware accelerator 254 to read from or write data to a set of non-contiguous buffers in physical address space that are mapped to a single contiguous region in virtual address space without an additional level of copying. As one will appreciate, while different types of data may occupy a contiguous block of memory in virtual address space, it may be mapped to a set of disjoint regions in physical address space. Linux adds support for the ready( )and writev( )commands which read from or write to a set of non-contiguous memory regions. The input to these functions is an array where each element contains a pointer to a region of memory together with its length. The memory interface allows the hardware accelerator to read data and write data to a set of non-continuous buffers.

FIG. 2C illustrates an embodiment of system architecture of a computing device with a closely attached “passive” hardware accelerator, in accordance with an embodiment of the present disclosure.

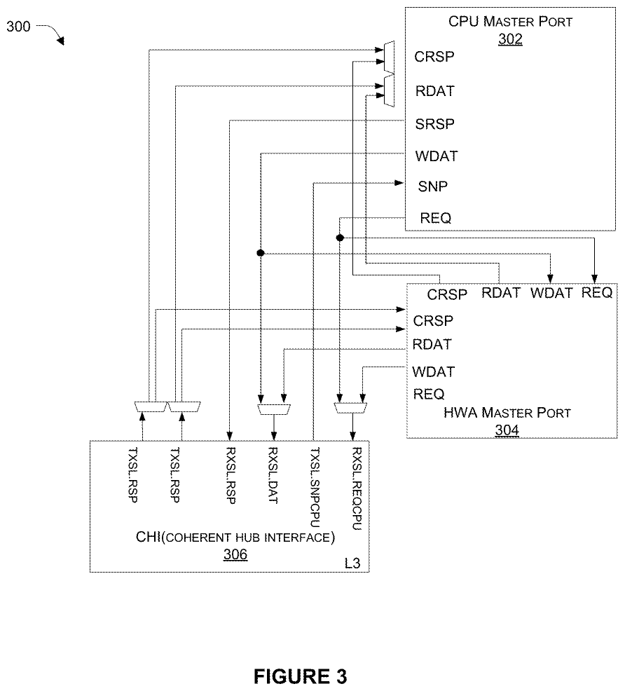

FIG. 3 illustrates an exemplary microarchitecture 300 of a system that has a hardware accelerator closely attached to a central processing unit in accordance with an embodiment of the present disclosure. An HWA master port 304 of the hardware accelerator can use a CHI interface 306 to transfer instructions and data from/to a CPU master port 302 of a processor unit (e.g., CPU). In an embodiment, the CHI interface 306 can be configured to process read and write requests of 64 bytes. 64-byte read and write requests are issued to the interconnect, improving write bandwidth relative to the tightly attached option. Read requests is issued with the ReadOnce command which indicates a coherent read that should not be cached.

The number of credits HWA has for the REQ and WDAT channels is configurable. The value should be chosen as a function of the data path width and the expected memory access latency. For instance, 2 credits would be required for peak processing with a 128-bit data path and a 30-cycle L3 hit latency. The hardware accelerator 254 behaves as an RN-I non-coherent node that connects to the CHI interconnect. The hardware accelerator 254 may have REQ, WDAT, RDAT, and CRSP channels to issue 64-byte line read and write requests. As one will appreciate, the system 250 does not have SNP and SRSP channels as it does not cache data.

Further, using the interrupt interface, the HWA uses the cluster level interrupt architecture to send an external interrupt back to a core, and using the exception interface, an unaligned exception is returned for an unaligned physical address.

As physical addresses also require an accompanying memory type, the HWA 254 can also contain memory configuration registers to perform physical memory checks. These are referred to as PMP/PMA registers in some processor architecture (e.g., RV cores). Firmware can mirror PMP/PMA configuration writes to the HWA 254. It should be noted that there are two configurations for the closely attached configuration. The existing one is called the ‘active’ configuration, and a new one, described below, is the ‘passive’ configuration.

In an embodiment, the hardware accelerator 254 can use a cluster-level interrupt architecture to send an external interrupt back to a processor unit (e.g., a core or any CPUs 252a-n). The hardware accelerator 254 can use an exception interface to ensure an unaligned exception in return for an unaligned physical address.

HWA attaches to the system bridge in the passive option 262 of FIG. 2C. It has the same interfaces as in the active option but the difference is that, unlike the active option, it does not initiate memory requests but encrypts(decrypts) data at the same rate as it arrives. Software configures a special register bank to process data associated with one or more data streams associated with the memory ports of the system bridge. Each data stream is assigned to a crypto pipe. Each bank monitors whether data belongs to a stream it is assigned to and encrypts or decrypts it in one or more of the pipes assigned to that bank. This configuration enables further optimizations in the OS and/or driver software to eliminate one or more levels of copying that accompanies loosely attached solutions. The crypto pipes need to be fully pipelined to support the passive configuration as they need to match the data rate. The crypto pipes are unfolded from a hardware perspective from a single stage of 2-cycles to 15 stages of 2-cycles to support fully pipelining AES-256. Keys must not be generated on-the-fly and must be pre-generated with this mode. Finally, a separate copy of the carryless multiply is instantiated per crypto pipe as there can be no contention for resources in this mode.

Tightly attached hardware accelerator and closely attached hardware accelerator can be customized to be used for specific applications or functions, such as cryptographic operations, transcendental floating point functions, quad-precision floating point functions, integer, and floating-point matrix multiplication, and training machine learning models using neural networks. Some embodiments of the disclosures are described with respect to a hardware accelerator designed for performing the cryptographic operation (referred to as cryptographic accelerator or crypto accelerator. However, the computing device with the proposed architecture can be used for other applications as well. Other applications or functions can be performed by the tightly attached hardware accelerator, with needed change in the data path and some control logic, while maintaining the similar software and hardware interfaces described herein.

Data centres encrypt and decrypt customer data as it moves through parts of their network that are not secure. Data can also be stored in an encrypted form inside the data centre to provide privacy for user data. There are 3 primary ways a processor running firmware in machine mode, kernel software in supervisor mode, or applications in user mode can perform encryption/decryption, taking the Linux operating system as an example. One of the ways includes Native crypto instruction set extensions (ISEs) where x86 and ARM ISAs have incorporated ISEs to accelerate cryptographic algorithms. These instructions can be used to accelerate encryption or decryption of data in any privilege mode. Other way includes OpenSSL API where calling the OpenSSL API gives firmware or software access to the full toolkit of key generation, a variety of state-of-the-art encryption/decryption algorithms, and data authentication via hashing. The OpenSSL libraries can be implemented in one of 3 ways including software libraries that use general-purpose instructions or non-crypto ISEs (e.g., bit manipulation extension in RISC-V), handwritten kernels that use crypto instructions, and using a crypto hardware accelerator. An example of an ARM-based SOC with a crypto accelerator is the Armada MV78xxx series. It has 2 crypto accelerators together with a security accelerator, which interfaces to memory via a DMA engine. Plain (cipher) text from DRAM is loaded into an internal SRAM, then encrypted (decrypted) and cipher (plain) text stored in the internal SRAM. The contents of the SRAM are then stored in DRAM. OpenSSL version 1.10 added support for an asynchronous mode through the ASYNC_JOB( )call, which allows both kernel and user code to offload crypto processing to an accelerator while continuing to work on other tasks. The application must be configured to support asynchronous mode if such connections exist. The initial OpenSSL function call will return to the application with an error status of SSL ERROR WANT ASYNC if an accelerator exists for the TLS connection. The application can then register for a file descriptor and use the standard epoll/select/poll calls to wait for a response. Once this is received, the application can then make a 2nd call to establish the connection. OpenSSL-1.10 has a notification infrastructure for the accelerator to notify the application when processing has been completed.

Another way of encryption/decryption includes attaching hardware accelerator using/dev/crypto API on Linux kernel. The /dev/crypto API on the Linux kernel allows user programs to access the lower-level encryption, decryption, and hashing functions provided by the kernel. One use of this feature is to support encrypted files using a file descriptor which encrypts/decrypts files transparently OpenSSL calls/dev/crypto to implement the higher-level cryptographic algorithm for the function being called. When native crypto ISEs are available, they can be used directly in a user space library which OpenSSL can link to and calls to/dev/crypto are not necessary.

RISC-V (RV) cores afford a unique opportunity to attach a hardware accelerator inside a processor cluster due to the open-source nature of the architecture.

The first RV Crypto ISE proposal, named the ‘K’ extension, is in the process of ratification. It includes instruction variants to support RV32 scalar, RV64 scalar, and vector implementations. The RV32/RV64 scalar instructions facilitate acceleration of crypto applications without the burden of adding vector support. The scalar RV32/RV64 instructions are intended to be used in conjunction with the bit manipulation instructions.

The lack of crypto instructions will result in a performance deficit relative to competitive systems when executing applications that benefit from crypto ISEs. The performance gap can be bridged using the system architecture with the hardware accelerator directly coupled with the processors.

Linux provides support to attach a hardware accelerator using/dev/crypto. Since the conventional accelerator is a device occupying a physical memory address range, its memory map is under the control of the operating system (OS). The hardware accelerator can only be made accessible to user code via a handle. There are two ways to access the hardware accelerator via the handle. In the first embodiment, the system for crypto acceleration invokes the hardware accelerator from inside /dev/crypto and provides a software driver for the hardware accelerator. In addition, a user-space library for the hardware accelerator is provided to allow an application like OpenSSL to link. This option requires a call to/dev/crypto whenever OpenSSL performs a specific operation. In a second embodiment, the system exposes the hardware accelerator's memory map to the user code using OS function call (e.g., Linux's mmap( )function call). Here again, a user-space library is needed to interface to the hardware accelerator, but the benefit is that no subsequent expensive kernel calls are needed to/dev/crypto, and OpenSSL can access the accelerator directly from user code.

The closely attached option can use either of the above options with the software driver using memory-mapped reads (MMR) to access the hardware accelerator 254. The system 200 with tightly attached hardware accelerators 204a-n allows a further benefit that no interaction with the kernel (e.g., Linux Kernel) would be necessary as the hardware accelerators 204a-n are part of the thread's virtual address space, and user code interacts with it using special registers. The system 200 with tightly attached hardware accelerator requires a patch to the save/restore context switch handler in the standard Linux distribution in order to save and restore HWA special registers.

For a specific processor architecture (e.g., RV), the patch can conditionally branch to a custom HWA, save state handler based on the value of “mstatus.XS”. The HWA handler will query HwaCtl, then issue a sequence of special register reads, followed by stores to store accelerator state in memory 208 if “mstatus.XS” is clean or dirty. A similar patch is needed on a restore where the “mstatus.XS” value in the save state would be queried followed by a branch to a custom restore handler, which would issue a sequence of loads followed by CSR writes to restore state if state.XS=clean or dirty.

The tightly attached hardware accelerator 204a-n of system 200 and the closely attached hardware accelerator 254 of system 250 would take several advantages over the loosely attached hardware accelerator 102 of the system 100. The tightly attached hardware accelerator 204a-n and closely attached hardware accelerator 254 provide low communication latency between core and hardware accelerator through either the CSR or MMR special register writes. These arrangements facilitate specific functions (e.g., crypto functions) offload from write-back memory for both small and large block sizes as well as the coarse-grained offload from I/O memory for large block size.

These arrangements (tightly attached hardware accelerator and the closely attached hardware accelerator) support two completion modes that can be dynamically configured. A system with these arrangements provides a synchronous mode where software can poll the “HwaCtl.Done” bit with a CSR or MMR read to determine completion and asynchronous mode where HWA asserts Hwalrq to indicate completion via a wire. The Hwalrq output can be used to generate an external interrupt request with an associated vector number. The accompanying HwaDone output will also be asserted together with Hwalrq, which mirrors the update of the HwaDone bit in the HwaCtl CSR, but it is redundant with Hwalrq in asynchronous mode. Asynchronous mode allows the software to execute other code while the HWA is in operation.

The systems 200 and the system 250 provide better exception reporting as compared to system 100. The systems of the present disclosure may use HwaExcp[3:0] output to indicate when one of the following types of exceptions occurred. The exceptions include

| | |
|---|---|
| 1) | Load or store access fault |
| 2) | Load or store page fault |
| 3) | Unaligned address fault |
| 4) | Data corruption |

The systems of the present disclosure also provide a better way to handle interrupts. The systems provide the ability for software to pause HWA processing by writing HwaCmd.Stop bit from 0->1. The HwaCmd.Ack bit can be polled in synchronous mode to determine that the HWA has acknowledged the request. In an embodiment, hardware accelerator processing can also be paused through the hardware interface by an assertion of an equivalent HwaStop input. HWA will assert the HwaAck output in response, after which the HwaStop input can be de-asserted. HwaAck, when asserted in response to HwaStop, indicates that HWA has reached a restartable state and has stopped processing. The HwaIdle indication asserts when HWA is quiescent. With the tightly attached option, the HwaIdle output can be input into the commit unit (CT), where it can be used to determine overall core quiescence. Pausing is needed when a timer interrupt is pending, because the OS wants to do a context switch for the current thread. The HWA needs to be paused, and its state saved so that processing can resume when the context is restored on the same or a different core. HWA waits for processing of the current data element to complete before it saves state to special registers and then asserts HwaAck. The state saved includes the number of 32-bit words that have been processed, which is stored in the HwaLen register, which is updated to reflect the number of dwords remaining. There may still be pending fill returns in progress when HwaAck is asserted. These fills have a register file entry to write to but will be dropped. HwaIdle will only be asserted when processing has stopped and all pending fill returns have been completed. The HwaXS output accompanies signalling of completion either through Hwalrq or HwaStopAck, which indicates whether HWA state is initial, clean, or dirty. Commit Unit (CT) can use HwaXS to update mstatus.XS on processor cores.

The proposed systems (system 200 and system 250) provide better ways to restart the hardware accelerator processing. The system can save and restore HWA state through special registers, which facilitates context switching with the additional requirement that the context switch handler needs to save and restore the HWA special register state, which will indicate the number of elements processed so far.

The systems also provide better security to operations or functions being executed by the hardware accelerator. All arithmetic and specific operations (e.g., Crypto operations) are performed in constant time. This property is more important in a software implementation than in a hardware accelerator in order to mitigate side-channel attacks.

Moving the hardware accelerator (e.g., hardware accelerator 204a-n, hardware accelerator 254) closer to the main processor units (e.g., CPUs 202a-n, CPU 252a-n) provides several benefits. The system avoids double movement of data from an I/O device to accelerator SRAM, then back again from accelerator SRAM to memory. A cluster-based accelerator (e.g., hardware accelerator 254) could directly output cipher (text) into the L2 or L3 cache, reducing L2 and L3 cache misses for code that is consuming the data. This would require input data to not be cached but output data to be cached. The proposed system does not require the addition of custom instructions, except for the addition of the HWA-specific special registers into the special register address space. The proposed systems allow for improved bandwidth over existing processor architectures (e.g., RV32/RV64 scalar crypto-based solution), as the width of the accelerator data path can be increased to 128-bits or 256-bits. In traditional systems, the core integer data path width is fixed at either 32-bits or 64-bits. In an embodiment, a hardware accelerator (e.g., a crypto accelerator) could also provide power efficiency and throughput improvement over an existing implementation (e.g., RV vector crypto implementation), as the data path width can be increased to a multiple of 128-bits that is greater than the vector data path width by using more than one pipe. The systems provide better energy efficiency than existing systems, as no power is dissipated due to fetch, rename, dispatch, and out-of-order scheduling of operation.

Further, adding a tightly or closely attached crypto hardware accelerator inside the cluster speeds up execution of the following types of algorithms in OpenSSL TLS 1.3.

| | |
|---|---|
| 1. | TLS_AES_256_GCM_SHA384 |
| 2. | TLS_CHACHA20_POLY1305_SHA256 |
| 3. | TLS_AES_128_GCM_SHA256 |
| 4. | TLS_AES_128_GCM_8_SHA256 |
| 5. | TLS_AES_128_CCM_SHA256 |

OpenSSL already supports a dynamic engine-based API which can be used to link to a hardware accelerator without recompilation of the source code. The most widely used encryption for internet communications is authenticated encryption with associated data (AEAD) with confidentiality provided by using the Galois/Counter Mode (GCM). AES is used for the block cipher with authentication based on the GHASH. The hardware accelerator will be optimized for processing with this mode using a 128-bit data path.

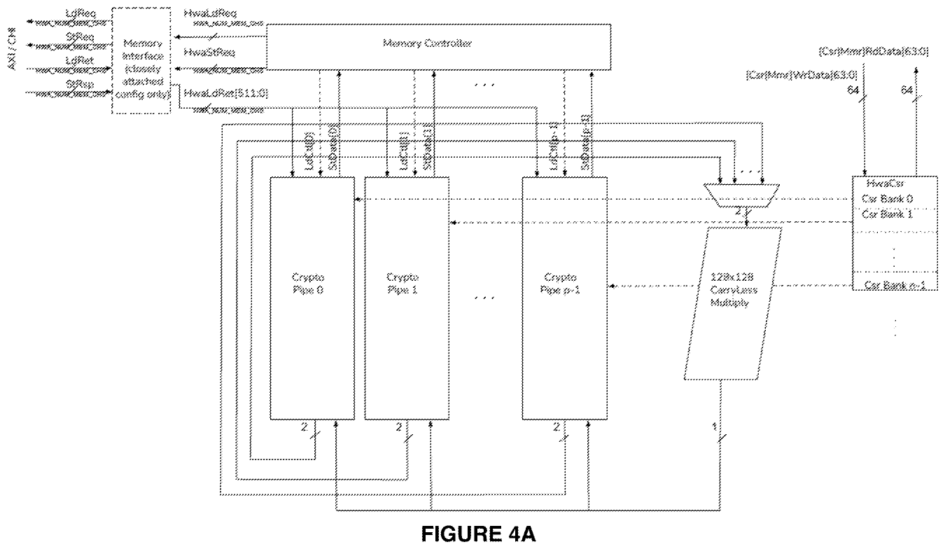

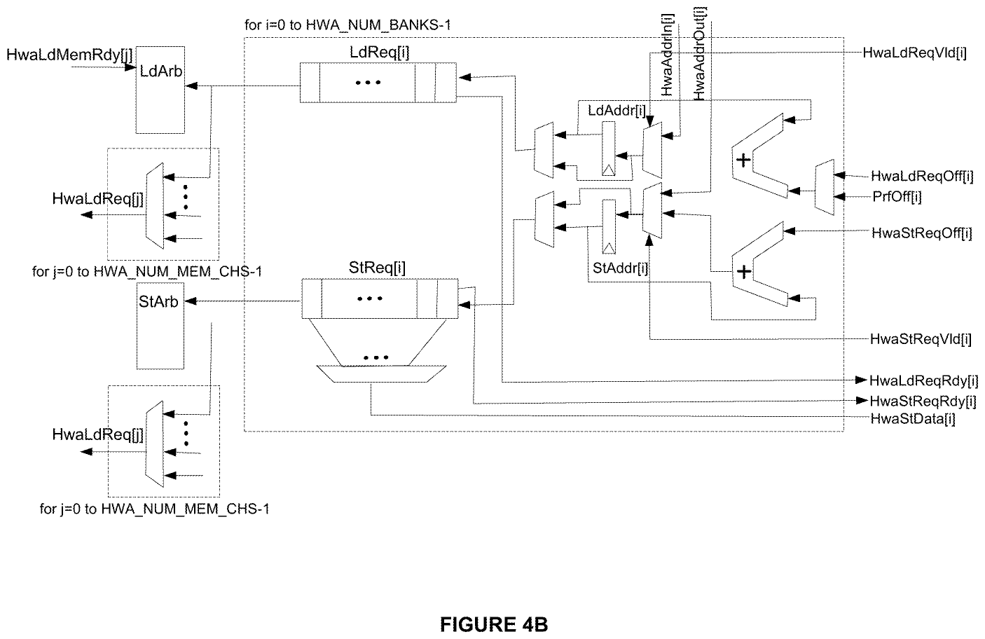

FIG. 4A illustrates an exemplary data path of a hardware accelerator designed to perform cryptography in accordance with an embodiment of the present disclosure. The HWA has ‘p’ crypto pipes 452a-n, a common Csr/Mmr block 456 with ‘n’ special register banks 458a-n, one for each thread, and a shared carry less multiplier. ‘n’ and ‘p’ are parameters that are statically configured at design time and can range from 1 to 8 depending on the crypto processing bandwidth requirements of the system.

The ‘n’ special register banks allow support for a multi-threaded system where a software thread can be allocated its bank. In a virtualized environment, a hypervisor could allocate or deallocate virtual machines to individual banks. One or more pipes can be allocated to a particular bank to improve single-thread bandwidth using the PipeAff field in HwaCfg.

The memory controller accepts ‘p’ load and ‘p’ store requests per clock. There is an arbiter that selects ‘n’ load and ‘n’ store requests to forward to the memory interface. This can be configured to support either AXI or CHI. The block has a dashed boundary to indicate that it is only needed in the closely attached configuration. The tightly attached configuration forwards the outputs of the memory controller directly to the processor.

There is one 64-byte load write port and one 16-byte read port for stores, for the tightly attached option, which is shared across all pipes. The store read port is widened to 64-bytes for the closely attached option.

Load requests would be submitted to a read queue in the L2 and store requests to a write queue in the tightly attached HWA. Both AXI and CHI interconnect options are supported for the closely attached HWA. The load requests would be sent to a TXREQ queue and the store requests to the WDAT queue for CHI, which are part of the HWA hierarchy.

The number of pipes 410a-n coupled to a CSR bank can be dynamically configured. The configuration can be updated while the HWA is in operation. The HwaCfg.PipeAff field, which indicates coupling of pipes to banks, is first written with the new value. Next, HwaCmd.Cfg is written to l′bl to indicate that the change should take effect. This will happen when HWA transitions to idle. HwaCmd.Ack will be asserted to indicate that the command has taken effect. For example, if there are eight banks and eight pipes, PipeAff[8*i+j] indicates whether pipe ‘j’ is coupled to bank′ i′. Possible configurations are two banks each could have access to 2 pipes in a 4-pipe configuration allowing two threads to share the HWA.

The register file contains microarchitecture registers that are only visible to the HWA. All entries can be configured to be 512-bits which can be organized as 4 banks of 128-bits wide. In an embodiment, the shared register file is moved inside the crypto pipe so that each pipe has its private register file. A private register file, located inside the crypto pipe, would have 3 read ports (2 compute+1 store) and 2 write ports (1 compute+1 load). Operands and results that are read and written by the crypto pipes 452a-n and the carry less multiplier 414 can be 128-bits wide, which requires a read or a write to a single bank.

The register file has multiple read ports, which totals ‘3+2*n’ read ports. The 1-pipe config may have 5 read ports, whereas the 4-pipe config may have 11 read ports. In an embodiment, two read ports for each crypto pipe can be configured. In an embodiment, two read ports for the carry less multiplier 454 and one read port can be configured for stores.

The register file may include multiple write ports, which totals ‘2+n’ write ports. The 1-pipe config may have four write ports, whereas the 4-pipe config may have six write ports. In an embodiment, one write port for each crypto pipe 410a-n, one write port for the carry less multiplier 454, and one write port for loads can be configured.

In an embodiment, the register file can be statically partitioned into sections that are used for each crypto pipe. For example, the register file can be partitioned into a HwaLd[15-0], 16×16-byte registers to hold up to 4×64-byte line fills, and a HwaRk[15-0], 16 round key registers produced from the key expansion. In some embodiments, the special register block HWACSR 456 may include several visible architecture registers, such as HwaCmd (command interface to start, stop and configure the HWA, HwaCtl (controls operation of the HWA and provides status), HwaCfg (controls configuration of the HWA), Hwalv[lh] (low/high 64/32-bits of 96-bit initialization vector for AES-GCM), HwaRk[lh] (low/high 64-bits of a 128-bit round key), HwaAutDat[lh] (low/high 64-bits of 128-bit authentication data), HwaAutTag[lh] (low/high 64-bits of 128-bit authentication tag), HwaAddrin (52-bit start VA of input plain/ciphertext block to encrypt/decrypt), HwaAddrOut (52-bit start VA of a block to store cipher/plain text output), and HwaLen (number of 32-bit elements to encrypt/decrypt).

The carry less multiply 454 data path may be redundant with respect to the carry less multiply data path in a certain core. However, the carry less multiply 414 can be a 128x128 multiplier, whereas the processing unit (also referred interchangeably as core) may support a 64×64 multiplier.

FIG. 4B shows memory interface of the hardware accelerator, in accordance with an embodiment of the present disclosure.

The memory interface consists of a number of memory channels through which a load or a store request can be issued. The number of memory channels is specified through a parameter, HWA_NUM_MEM_CHS, which is passed to the top-level instance. A definition indicates the type of memory protocol, which can be either AXI or CHI.

The block diagram in FIG. 4B shows the memory interface with the inward-facing interface to the HWA pipes on the right and the outward-facing interface to memory on the left. The ‘n’ crypto pipes issue load requests to the memory interface specifying an offset, LdReqOff[i], relative to the starting address, AddrIn[i]. Similarly store requests specify StReqOff[i]. These are referred to as demand requests. A new load demand request offset is added to the current load address and allocated into the load request FIFO, LdReq, per bank. A next line prefetcher which can prefetch up to the next ‘n’ consecutive, can be active which can specify a prefetch offset through a 2-1 mux. The prefetcher hides memory latency which can be substantial, when the load misses in the L3 or last level cache and has to go out to DRAM. There is no prefetcher for store requests which are allocated into a store request FIFO, StReq, per bank. There are separate arbiters for load and store requests as each have separate interfaces within a memory channel. The arbiter, represented by the ‘Arb’ block in the diagram, uses a SRRIP algorithm to keep track of the priority of incoming requests and issues one grant, MemReqGrnt[j], per memory channel. When a bank has received a grant, it can deallocate the corresponding request

FIFO and increment its read pointer. There is a valid/ready interface with the memory channel. When the ready input is deasserted, the arbiter will not dispatch any request to that channel. When a FIFO is full, LdReqRdy[i] or StReqRdy[i] to the bank is deasserted which prevents new requests from being accepted. The bank will continue to issue the same request until the ready signal is asserted again. Supporting more than one memory channel as well as prefetching allows the memory latency of a pipe request to be overlapped with its computation which improves peak execution bandwidth.

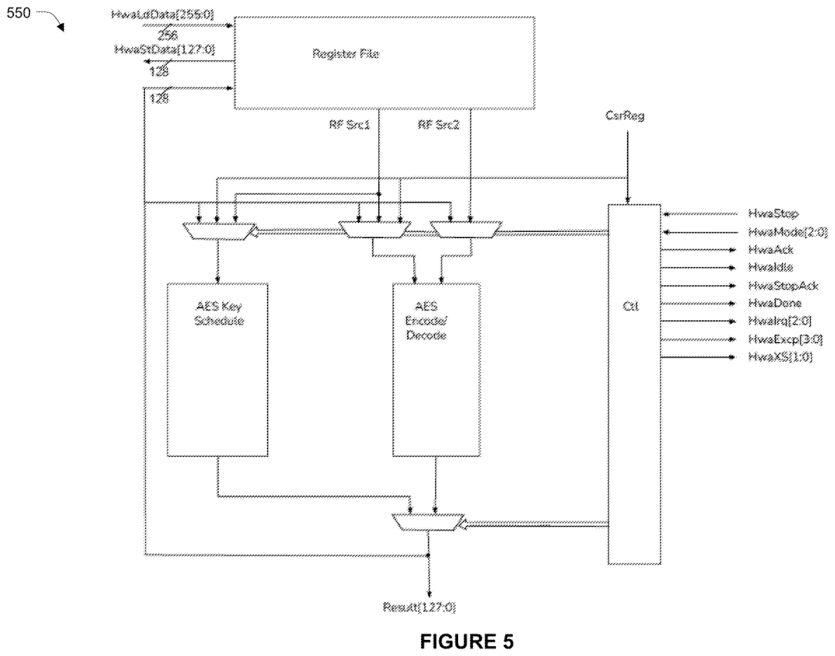

FIG. 5 shows a private register file and illustrates detailed logic used inside one of the crypto pipes in accordance with an embodiment of the present disclosure. As shown in FIG. 5, each crypto pipe (e.g., crypto pipe 502a, crypto pipe 502b, and crypto pipe 502n) work as one pipelined functional unit, which takes two clock cycles to perform one of the following three operations (AES schedule, AES encode, and AES decode). The AES width is an input to the operation from the corresponding CSR bank and can be AES-128, AES-192, or AES-256. The control unit (CTL) 504 can ensure that there is no contention for any shared resources such as register files, write ports, or bypass paths. The control unit 504 ensures pipelines are stall-free. A pipe can be configured to support on-the-fly key expansion or to generate and store the keys in the register file at the start. A pipe performs all rounds of processing on each data element. Processing for a second data element can be pipelined behind the first one as the data path is pipelined. Encryption/decryption algorithms, such as AES-128 (11 rounds), AES-192 (13 rounds), AES-256 (15 rounds), AES128-GCM, AES192-GCM, AES256-GCM, and SM4-GCM (8 rounds) can be supported via a state machine. SM4 encode/decode requires a 4-cycle data path because it requires a higher logic depth to implement than AES. The dword computed in cycle ‘i’ is a function of the sbox output of one or more dwords computed in previous cycles and the critical path is through chaining sboxes together.

In some embodiments, control logic for the hardware accelerator (e.g., hardware accelerator 204a-n, hardware accelerator 254) can be implemented using a state machine to schedule specific functions or operations (e.g., encryption/description rounds for each 128-bit block of plain/ciphertext). The state machine can be configured based on the specific functions to be executed by the hardware accelerator. The hardware accelerator processing is started or resumed by a CSR write to HwaCmd.Start. Completion can be determined through the software interface by first reading the HwaCmd.Ack to check that the command was accepted and then, reading HwaCtl.Idle and HwaCtl.Done bits to check that processing has been completed. When using the hardware interface, completion can be determined by sensing values on HwaAck, HwaIdle, and HwaDone. A non-zero value is written to HwaCtl.Irq[2:0] when an exception is encountered, and the same value will be output on HwaIrq[2:0]. In general, the hardware signals reflect the state of the corresponding bits in the HwaCtl csr. The HwaCmd csr contains only write-only and read-only bits and does not need to be saved and restored.

The special register block, HwaCsr, contains the following software visible 64-bit architectural registers.

HwaCmd - interface to start, stop and configure the HWA and
provide status
HwaCtl - indicates which operation HWA should work on
HwaCfg - controls configuration of the HWA
HwaIv[lh] - low/high 64/32-bits of 96-bit initialization
vector for AES-GCM
HwaRk[lh] - low/high 64-bits of 128-bit round key
HwaAutDat[lh] - low/high 64-bits of 128-bit authentication
data
HwaAutTag[lh] - low/high 64-bits of 128-bit authentication
tag
HwaAddrIn - 52-bit start VA of input plain/cipher text block
to encrypt/decrypt
HwaAddrOut - 52-bit start VA of block to store cipher/plain
text output
HwaMtval - 52-bit VA of element with exception (only in
tightly attached config)
HwaAddrInList - 52-bit PA pointer to input list of memory
regions to process
HwaAddrOutList - 52-bit PA pointer to output list of memory
regions
HwaLen - number of 32-bit elements to encrypt/decrypt

The carry less multiply data path may be redundant with respect to an existing carry less multiply data path in the tightly attached configuration. However, it is a 128x128 multiplier for faster throughput whereas cores typically have a 64×64 multiplier.

The hardware accelerator has a Digital Random Number Generator (DRNG) which can be used to produce random numbers which can in turn be used to seed a Pseudo Random Number Generator (PRNG). The DRNG is implemented in the HwaRnd module which is shared across threads as it is accessed at the start of a thread to produce a random seed or cryptographic key. The seed can be further conditioned using a cryptographic algorithm such as AES. HwaRnd has access to an entropy source whose values meet the properties of statistically independent, uniformly distributed and unpredictable.

The entropy source is based on a bi-stable digital circuit consisting of 2 free running oscillators which when sampled settle to one of the two oscillator output values. The logic uses digital gates with no analogue circuitry. When HwaCtl.Drng is set to 1′b1, HwaRnd will start sampling the entropy source to produce a seed which can be configured to a width of 16-bits, 32-bits, or 64-bits. On completion, HwaCmd.Ack will be asserted. If successful, the output seed will be returned in HwaDrng. If an error occurred, HwaCtl.Excp will be set to an error status. Software can poll HwaCmd.Ack to determine when the random number generation has completed.

The control logic associated with the hardware accelerator implements a state machine to schedule encryption(decryption) rounds for each 128-bit block of p lain(cipher) text. The state machine will get configured based on the encryption(decryption) algorithm requested via the csr write to the HwaCtl register.

HWA processing is started or resumed by a csr write to HwaCtl. Completion can be determined through the software interface by first reading the HwaCtl.Ack to check that the command was accepted and then, reading HwaCtl.Idle and HwaCtl.Done bits to check that processing has been completed. When using the hardware interface completion can be determined by sensing values on HwaAck, HwaIdle, and HwaDone. A non-zero value will be written to HwaCtl.Irq[2:0] by HWA when an exception is encountered and the same value will be output on HwaIrq[2:0]. In general, the hardware signals reflect the state of the corresponding bits in the HwaCtl csr. The HwaCtl csr contains only write-only and read-only bits and does not need to be saved and restored. A description of these bits is included in the Csr section.

In an embodiment, the following instruction sequence may be used to configure the HWA to perform AES-GCM encryption or decryption on a block of ‘n’ 32-bit elements in synchronous mode. This is followed by csr reads from HwaCtl to poll for completion.

| | |
|---|---|
| mv | x11, #hwactl_idle_val; hwactl.idle = 1 |
| mv | x12, #hwactl_mode_val; hwactl.mode = sync, |
| | hwactl.type = aes-gcm |
| mv | x13, #hwacmd_start_val; hwacmd.start = 1 |
| mv | x14, #hwacmd_ack_val; hwacmd.start = 0, hwacmd.ack = 1 |
| mv | x15, #hwactl_done_val; hwactl.done = 1, hwactl.idle = 1 |
| | hwa_not_idle: |
| csrrs | x1, hwactl, x0; read hwactl |
| bne | x1, x11, hwa_not_idle; poll until hwactl.idle = 1 |
| csrrw | x0, hwaivl, <ivl_val>; write IV low |
| csrrw | x0, hwaivh, <ivh_val>; write IV high |
| csrrw | x0, hwarkl, <rkl_val>; write RK low |
| csrrw | x0, hwarkh, <rkh_val>; write RK high |
| csrrw | x0, hwaaddrin, <addrin_val>; write address of |
| | input block |
| csrrw | x0, hwaaddrout, <addrout_val>; write address of |
| | output block |
| cssrw | x0, hwalen, <len_val>; write number of 32-bit elements |
| | to process |
| csrrsw | x0, hwactl, x12; set hwactl.mode = sync, type = aes- |
| | gcm |
| csrrsw | x0, hwacmd, x13; set hwacmd.start = 1 |
| | hwa_start: |
| csrrs | x1, hwacmd, x0; read hwacmd |
| bne | x1, x14, hwa_start; poll until hwacmd.start = 0, |
| | hwacmd.ack = 1 |
| | hwa_not_done: |
| csrrs | x1, hwactl, x0; read hwactl |
| bne | x1, x15, hwa_not_done; poll hwactl.done = 1, |
| | hwactl.idle = 1 |

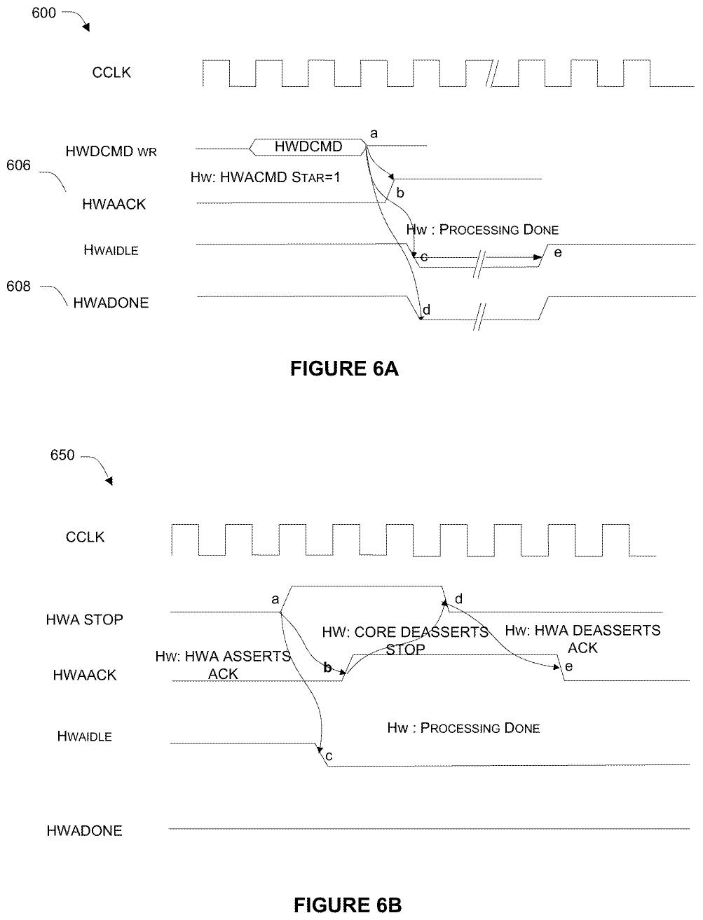

FIG. 6A is a timing diagram illustrating how signal transitions on the hardware interface of the hardware accelerator when accepting, processing, and completing a request, in accordance with an embodiment of the present disclosure. The timing diagram 600 shows the signal transitions on the HWA hardware interface when accepting, processing, and completing a request associated with the software sequence above. As shown in FIG. 6A, the write command “HwaCmd wr 602” is sent to the hardware accelerator. The hardware accelerator acknowledges (HwaAck 604) receipt of the instruction, starts processing, and updates HwaIdle 606 register. While the hardware accelerator processes the assigned task, its status is shown as not idle. When the task is completed, the HwaIdle 606 register updates the status and shows the hardware accelerator as idle. HwaDone 608 register can similarly be updated to reflect the task completion status. The hardware accelerator can be interrupted.

FIG. 6B is a timing diagram illustrating how to stop a request is processed in accordance with an embodiment of the present disclosure. The timing diagram 650 shows the signal transitions on a hardware interface of the hardware accelerator when the core pauses hardware accelerator processing by asserting the HwaStop 652 input. The hardware accelerator responds with HwaAck 654 assertion when it is able to transition to a state that it can be restarted from, referred to as a Restartable state. In the restartable state, the hardware accelerator performing encryption/decryption should ensure that the key expansion has completed if on-the-fly key generation is disabled, and all encryption/description rounds to process the current element have finished. The requirement of key expansion being completed reduces the number of states that require to enable the property of restarting. Key expansion generates keys and writes them to intermediate registers, HwaRk[15-0], which are used for all the rounds. When HWA is restarted, it assumes that keys are available in the register file. Hardware accelerator asserts HwaIdle 656 and HwaAck 654 when it has transitioned to a restartable state, as shown in the following timing diagram. HwaDone 658 is accordingly updated. In an embodiment, a 4-phase signalling protocol between the HwaStop input and HwaAck output can be used to accept and acknowledge the stop processing request from the core. A HwaLen register is updated with the number of elements that have been completed. A core (e.g., RISC-V core, also referred to as RV core) may also set mstatus.XS[1:0] appropriately based on HwaXS, which indicates the state of a user extension as off, initial, clean or dirty. These bits can then be used by the OS context switch handler to skip, save/restore the HWA state. After HwaCtl is restored on a state restore, HwaCmd.Start must be set to l′bl to resume processing. HwaAddrin, HwaAddrOut, and HwaLen can be updated on the prior HwaStop request to allow resumption of processing from the next element. As one may appreciate, while the above sequence shows how a stop request initiated by hardware is handled, a stop request may also be sent by software by writing HwaCmd.Stop to l′bl.

In an embodiment, the HWA may be configured to generate round keys on-the-fly to reduce start up latency for smaller data blocks. The default mode is to generate the keys first and then store them in the register file. As the same keys are re-used for all data blocks in a stream, this saves power at the expense of a small start up latency.

In an embodiment, the HWA can be configured to enable a simpler next-line prefetching scheme to hide the latency of the memory subsystem. The prefetcher can be configured to fetch up to +1 to +8 next lines.

In an embodiment, HWA may include one clock domain and one reset domain. The RESET input pin must be asserted for a minimum of 2 cycles to reset the HWA. An SOC may include clock domain crossing (CDC) and/or asynchronous FIFOs to and from the HWA on its interfaces if the SOC logic is in a different clock domain.

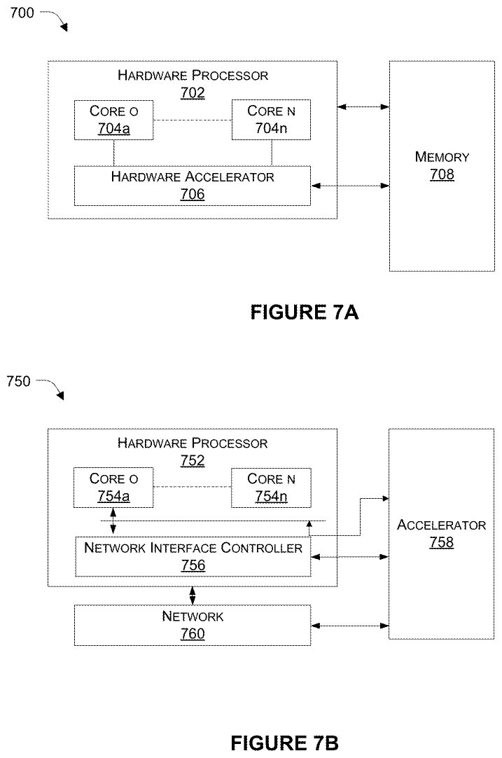

FIG. 7A illustrates an exemplary system 700 having a hardware processor 702 attached with a hardware accelerator 706 in accordance with an embodiment of the present disclosure. Hardware processor 702 (e.g., core 704a-n) may receive a request (e.g., from software) to perform a computationally extensive task (e.g., blockchain transaction) and may offload performing (e.g., at least part of) the task to a closely attached hardware accelerator 706. Hardware processor 702 may include one or more cores 704a-n. In one embodiment, each core may communicate with hardware accelerator 706 through a coherent hub interface. In one embodiment, each core may communicate with (e.g., be coupled to) one of the multiple hardware accelerators. Core(s), accelerator(s), and memory (e.g., data storage device) 708 may communicate (e.g., be coupled) with each other. Arrows indicate two-way communication (e.g., to and from a component), but one-way communication may be used. In one embodiment, a core (e.g., core 704a, or any core) may communicate (e.g., be coupled) with the memory 708, for example, storing and/or outputting data and instructions. Hardware accelerator 708 may include any hardware (e.g., circuit or circuitry) discussed herein.

FIG. 7B illustrates another exemplary system 700 having a hardware processor 752 attached with a hardware accelerator 758 in accordance with an embodiment of the present disclosure. In one embodiment, a hardware accelerator 758 is closely attached to a hardware processor 752 and maybe on the same die. In one embodiment, a hardware accelerator 758 can be off the die of a hardware processor. In one embodiment, system 750 includes at least a hardware processor 752 and a hardware accelerator 758 as a system-on-a-chip (SoC). A core (e.g., any core 754a-n) of the hardware processor 752 may receive a request (e.g., from software) to perform a computationally extensive task (e.g., blockchain transaction, encryption/decryption, etc.) and may offload performing (e.g., at least part of) the task to a hardware accelerator (e.g., hardware accelerator 758). Hardware processor 752 may include one or more cores (0 to N). In one embodiment, each core may communicate with (e.g., be coupled to) hardware accelerator 754. In one embodiment, each core may communicate with (e.g., be coupled to) one of the multiple hardware accelerators. Core(s), accelerator(s), and memory (e.g., data storage device) may communicate (e.g., be coupled) with each other. Arrows indicate two-way communication (e.g., to and from a component), but one-way communication may be used. In one embodiment, an (e.g., each) core may communicate (e.g., be coupled) with the memory, for example, storing and/or outputting data. A hardware accelerator may include any hardware (e.g., circuit or circuitry) discussed herein. In one embodiment, an (e.g., each) accelerator may communicate (e.g., be coupled) with the memory, for example, to receive data. The hardware processor 752 may have a closely attached network interface controller (NIC) 756. NIC 756 may be a network accelerator. NIC 756 may provide an interface to networks (e.g., network 760) that utilize the Internet Protocol suite of networking protocols. NIC 756 may respond to various types of networking protocol packets, e.g., without involving the processor. Additionally, NIC 756 may perform (e.g., a portion of) the task. Network 760 may provide access to other network nodes executing the task in a distributed manner.

The system as described in embodiments above can be any computer system. Examples of a computer system also referred to as a computer or computing device may include but are not limited to a personal computer(s), a laptop computer(s), a mobile computing device(s), a server computer, a series of server computers, a mainframe computer(s), or a computing cloud(s). In some implementations, each of the aforementioned may be generally described as a computing device. In certain implementations, a computer system may be a physical or virtual device. In some embodiment, the computer is also referred to as a remote computer. In many implementations, a computing device may be any device capable of performing operations, such as a dedicated processor, a portion of a processor, a virtual processor, a portion of a virtual processor, a portion of a virtual device, or a virtual device.

In some implementations, a processor may be a physical processor or a virtual processor. In some implementations, a virtual processor may correspond to one or more parts of one or more physical processors. In some implementations, the instructions/logic may be distributed and executed across one or more processors, virtual or physical, to execute the instructions/logic. The computer system may execute an operating system, for example, but not limited to, Microsoft® Windows®; Mac® OS X®; Red Hat® Linux®, or a custom operating system. (Microsoft and Windows are registered trademarks of Microsoft Corporation in the United States, other countries, or both; Mac and OS X are registered trademarks of Apple Inc. in the United States, other countries, or both; Red Hat is a registered trademark of Red Hat Corporation in the United States, other countries or both; and Linux is a registered trademark of Linus Torvalds in the United States, other countries or both).

In some implementations, the instruction sets and subroutines of a computer system, which may be stored on a storage device, coupled to the computer system, may be executed by one or more processors (not shown), one or more tightly attached hardware accelerators, one or more closely attached hardware accelerators and one or more memory architectures included within the computer. In some implementations, storage device attached to the computer system may include but is not limited to: a hard disk drive; a flash drive, a tape drive; an optical drive; a RAID array (or other arrays); a random-access memory (RAM); and a read-only memory (ROM).

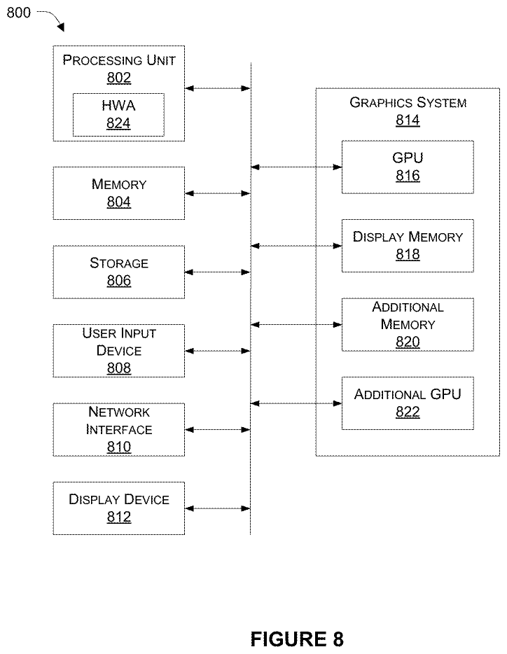

FIG. 8 illustrates components of an example computer system in accordance with an embodiment of the present disclosure. A computer system 800 includes a processing unit 802 for running specific applications and, optionally, an operating system. The processing unit 802 includes a tightly attached hardware accelerator 824 designed to process specific tasks (e.g., encryption/decryption). As illustrated, computer system 800 further includes database 804 (hereinafter, sometimes referred to as memory 804), which stores applications and data for use by CPU 802 and hardware accelerator 824. Storage 806 provides non-volatile storage for applications and data and may include fixed disk drives, removable disk drives, flash memory devices, and CD-ROM, DVD-ROM, or other optical storage devices. Optional user input device 808 includes devices that communicate user inputs from one or more users to computer system 800 and may include keyboards, mice, joysticks, touch screens, etc. Communication or network interface 810 is provided, which allows computer system 800 to communicate with other computer systems via an electronic communications network, including wired and/or wireless communication and an Intranet or the Internet. In one embodiment, computer system 800 receives instructions and user inputs from a remote computer through communication interface 810. Communication interface 810 can include a transmitter and receiver for communicating with remote devices. Optional display device 812 may be provided, which can be any device capable of displaying visual information in response to a signal from processing unit 802, in computer 800.

In the embodiment of FIG. 8, graphics system 814 may be coupled with data bus 860 and the components of computer 800. Graphics system 814 may include physical graphics processing unit (GPU) 816 and graphics memory. GPU 816 generates pixel data for output images from rendering commands. Physical GPU 816 may be configured as multiple virtual GPUs that may be used in parallel (concurrently) by several applications or processes executing in parallel. For example, mass scaling processes for rigid bodies or a variety of constraint-solving processes may be run in parallel on multiple virtual GPUs. Graphics memory may include display memory 820 (e.g., a frame buffer) used for storing pixel data for each pixel of an output image. In another embodiment, the display memory 820 and/or additional memory 822 may be part of memory 804 and may be shared with CPU 802. Alternatively, display memory 820 and/or additional memory 822 can be one or more separate memories provided for the exclusive use of graphics system 814. In another embodiment, graphics system 814 includes one or more additional GPUs 824. Each additional GPU 824 may be adapted to operate in parallel with GPU 816. Each additional GPU 824 generates pixel data for output images from rendering commands. Each additional physical GPU 824 can be configured as multiple virtual GPUs that may be used in parallel (concurrently) by several applications or processes executing in parallel, e.g., processes that solve constraints. Each additional GPU 824 can operate in conjunction with GPU 816, for example, to simultaneously generate pixel data for different portions of an output image or to simultaneously generate pixel data for different output images. Each additional GPU 824 may be located on the same circuit board as GPU 816, sharing a connection with GPU 816 to data bus 860, or each additional GPU 824 may be located on another circuit board separately coupled with data bus 860. Each additional GPU 824 can also be integrated into the same module or chip package as GPU 816. Each additional GPU 824 can have additional memory, similar to display memory 820 and additional memory 822, or can share memories 820 and 822 with GPU 816. It is to be understood that the circuits and/or functionality of GPU as described herein could also be implemented in other types of processors, such as general-purpose or other special-purpose coprocessors, or within a CPU. The components of computer system 200, including CPU 802 having tightly attached hardware accelerator 824, memory 804, data storage 806, user input devices 808, communication interface 810 and display device 812, and of graphics system 814 may be coupled via one or more data buses 826.

While embodiments of the present invention have been illustrated and described, it will be clear that the invention is not limited to these embodiments only. Numerous modifications, changes, variations, substitutions, and equivalents will be apparent to those skilled in the art without departing from the spirit and scope of the invention, as described in the claims.

Thus, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular name.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document, terms “coupled to” and “coupled with” are also used euphemistically to mean “communicatively coupled with” over a network, where two or more devices are able to exchange data with each other over the network, possibly via one or more intermediary devices.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

While the foregoing describes various embodiments of the invention, other and further embodiments of the invention may be devised without departing from the basic scope thereof. The scope of the invention is determined by the claims that follow. The invention is not limited to the described embodiments, versions, or examples, which are included to enable a person having ordinary skill in the art to make and use the invention when combined with information and knowledge available to the person having ordinary skill in the art.

The foregoing description of embodiments is provided to enable any person skilled in the art to make and use the subject matter. Various modifications to these embodiments will be readily apparent to those skilled in the art, and the novel principles and subject matter disclosed herein may be applied to other embodiments without the use of the innovative faculty. The claimed subject matter set forth in the claims is not intended to be limited to the embodiments shown herein but is to be accorded to the widest scope consistent with the principles and novel features disclosed herein. It is contemplated that additional embodiments are within the spirit and true scope of the disclosed subject matter.

What is claimed is:

1. A computing device, comprises:
a cluster of processors; and
one or more hardware accelerators directly coupled with the cluster of processors to facilitate acceleration of at least one of firmware, kernel and an application software associated with the computing device, wherein selected one of said cluster of processors from the cluster of processors is directly coupled with a dedicated hardware accelerator from the one or more hardware accelerators by interfacing the dedicated hardware accelerator with one of Load Store Unit (LS) and Level 2 cache of corresponding processor from the cluster of processors using virtual address of the corresponding processor.

2. The computing device of claim 1, wherein each of the one or more hardware accelerators comprises one or more first interfaces with memory subsystem of the corresponding processor, wherein the one or more first interfaces comprises special register interface, memory subsystem interface and Completion/Interrupt/Exception interface with commit unit of the corresponding processor.

3. The computing device of claim 1, wherein the one or more hardware accelerators along with the cluster of processors are configured to perform operations selected from crypto acceleration, transcendental floating-point functions, quad-precision floating point, integer and floating-point matrix multiply, and machine learning using neural networks for training.

4. A computing device, comprises:
a cluster of processors;
a hardware accelerator directly coupled with the cluster of processors to facilitate acceleration of at least one of firmware, kernel and an application software associated with the computing device, wherein the hardware accelerator is directly coupled with the cluster of processors by interfacing the hardware accelerator with standard interconnect associated with the cluster of processors using physical addresses of the cluster of processors.

5. The computing device of claim 4, wherein the hardware accelerator comprises one or more second interfaces with the cluster of processors, wherein the one or more second interfaces comprise Memory Mapped Register (MMR) interface, an interrupt interface and an exception interface.

6. The computing device of claim 5, wherein said memory interface comprises a CHI or AXI memory interface

7. The computing device of claim 5, wherein said hardware accelerator further comprises a closely attached hardware accelerator for interfacing to a standard industry interconnect comprising physical addresses, said closely attached hardware accelerator for sharing across multiple processor cores.

8. The computing device of claim 5, wherein said hardware accelerator further comprises a closely attached hardware accelerator that attaches to the system bridge of the computing device in passive mode, to enable data processing at a rate that matches the data rate into and out of the system bridge.

9. The computing device of claim 4, wherein the hardware accelerator along with the cluster of processors are configured to perform operations selected from crypto acceleration, transcendental floating-point functions, quad-precision floating point, integer and floating-point matrix multiply, and machine learning using neural networks for training.

10. A hardware accelerator for performing an operation of crypto acceleration comprises:
first predefined number of crypto pipes;
a common special register/MMR block with second predefined number of special register banks; and
a shared carry less multiplier, wherein the first predefined number and the second predefined number is selected based on crypto processing bandwidth requirements of a computing device comprising the hardware accelerator,
wherein the hardware accelerator is directly coupled with a cluster of processors of the computing device, to perform the operation of the crypto acceleration.

11. The hardware accelerator of claim 9, wherein a crypto pipe from the first predefined number of crypto pipes comprises a pipelined functional unit configured to take two clock cycles to perform at least one of Advanced Encryption Standard (AES) key schedule, AES encode, and AES decode.
